(19) United States
(12) Patent Application Publication
(10) Pub. No.: US 2009/0176079 A1
(43) Pub. Date: Jul. 9, 2009

(54) PROCESS FOR THE PRODUCTION OF POROUS CARBON MOULDINGS

(76) Inventors: Karin Cabrera-Perez, Dreieich (DE); Phillip Adelhelm, Berlin (DE); Bernd Smarsly, Potsdam (DE); Markus Antonietti, Nuthetal (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/302,403

(22) PCT Filed: Apr. 28, 2007
(86) PCT No.: PCT/EP2007/003793

§ 371 Date: Nov. 25, 2008

(30) Foreign Application Priority Data
May 31, 2006 (EP) 06011198.6

(51) Int. Cl. C04B 35/00; C01B 31/00; B32B 3/26; C01B 31/02; B01D 15/08

(52) U.S. Cl. 428/219; 264/29.1; 428/221; 428/304.4; 423/445 R; 210/198.2

(57) ABSTRACT

The present invention relates to a process based on phase separation for the production of porous carbon monoliths, to the monoliths produced in accordance with the invention, and to the use thereof.

The invention relates to a process based on phase separation for the production of porous carbon mouldings, to the mouldings produced in accordance with the invention, and to the use thereof.

Monolithic materials based on carbon are now being used in a wide variety of industrial areas owing to their particular material properties. Carbon monoliths have a relatively low weight compared with many other materials, exhibit high adsorptive power, high thermal conductivity and high thermal stability and generally have adequate mechanical stability.

Carbon monoliths or carbon mouldings are used, for example, as electrodes in fuel cells, as adsorbents for liquids and gases, as storage medium for gases, as support material in chromatographic applications or catalytic processes, as material in machine construction or in medical technology (DE 20 2004 006 867 U1).

Porous or nonporous carbon monoliths can be produced. For some applications, such as, for example, for use as sorbent in chromatographic processes or as storage medium, it is necessary to employ porous monolithic materials having sufficiently large surface areas.

Porous carbon monoliths can be produced in the simplest case by pyrolysis or carbonisation of porous or foamed starting materials (for example explained in DE 20 2004 006 867 U1). However, it is virtually impossible here to influence the pore-size distribution.

US 2005/0169829 describes in the introduction the production of porous carbon monoliths by polymerisation of carbonisable compounds into porous silica monoliths as templates and subsequent removal of SiO₂ by dissolution. In addition, a process is disclosed for the production of carbon monoliths having a hierarchical pore distribution in which a carbon former is mixed with one or more particulate pore formers as templates for the pores to be formed. After carbonisation of the carbon former, the templates are removed, giving a porous carbon monolith.

GB 2,157,482 discloses the production of porous carbon layers, where the pores are produced by the addition of particulate pore formers, which are burnt out during the carbonisation.

DE 20 2004 006 867 U1 likewise discloses the use of particulate pore formers which can be washed or burnt out after formation of the monolithic moulding.

It is thus necessary in all cases to add template monoliths or template particles to the reaction mixture in order to produce carbon monoliths having certain pore-size distributions. These processes are complex and inflexible since different template molecules have to be employed for each pore size. In addition, template monoliths and particles consisting of silica gel have to be dissolved out again later by complex chemical methods (by dissolution using HF or NaOH). In addition, hierarchical pore-size distributions are only possible with difficulty, in particular if, for example for chromatographic applications, materials having interconnected macropores and mesopores in the walls of the macropores are to be prepared.

The object of the present invention was therefore to provide a process by means of which porous carbon monoliths having variable pore sizes and variable pore-size distributions, in particular hierarchical bimodal or oligomodal pore-size distributions, can be produced. It should be possible here specifically to influence the pore structure of the product through the choice of the starting materials or reaction conditions. A further object was to develop carbon monoliths having large surface areas in order to obtain sufficiently large surface areas for interaction with various molecular species.

It has been found that porous carbon monoliths can be produced by means of a process based on phase separation, in which
a carbon former and an organic polymer are at least partially, preferably completely, dissolved in an organic solvent,
during evaporation of the solvent during concentration, at least partial phase separation occurs, which may continue during the carbonisation,
after removal of the organic solvent and the organic polymer by heating (for example pyrolysis, carbonisation) and/or extraction, a porous carbon material having a monomodal, bimodal or oligomodal pore distribution is obtained whose pore structure is retained after carbonisation.

Without wishing to stipulate a certain reaction mechanism, it is assumed that microphase separation between the solid constituents (carbon former and organic polymer) on the one hand and the solvent on the other hand occurs during evaporation of the solvent and/or during one of the subsequent steps of material synthesis. This is to be compared with spinodal decomposition as is known, for example, for the production of silica-gel monoliths by a sol-gel process (Nakanishi, J. Porous Mater. 1997, 4, 67-112). The macroporous structures are thus probably produced by macroscopic phase separation between the carbon former and the organic polymer, while the micro- and/or mesoporous structures are produced by the removal of the regions enriched with residues of organic polymer.

The present invention therefore relates to a process for the production of porous monolithic carbon mouldings by
a) preparation of a mixture which comprises at least one carbon former and one organic polymer in an organic solvent
b) evaporation of the solvent until a viscous or highly viscous material or a corresponding moulding is obtained
c) optionally shaping of the material or moulding obtained in step b)
d) heating of the material or moulding from step b) or c) to temperatures between 200 and 4000° C.

In a preferred embodiment, the carbon former employed is pitch.

In a particularly preferred embodiment, the carbon former employed is mesophase pitch.

In another preferred embodiment, the organic polymer employed is polystyrene.

In a preferred embodiment, a Lewis acid is added to the mixture in step a).

In a preferred embodiment, the heating of the moulding in step c) is carried out stepwise, firstly to temperatures between 200 and 400° C. and then to temperatures between 500 and 1000° C.

In another preferred embodiment, a mixture is prepared in step a) which comprises two or more different organic polymers of different molecular weight or one organic polymer in two or more different molecular weights.

In another preferred embodiment, one or more plasticizers are added to the mixture from step a).

In another preferred embodiment, the shaping in step c) is carried out by extrusion.

In another preferred embodiment, an extraction is carried out after step b) or step c).

In another preferred embodiment, the material or moulding is activated before or during one or more of the process steps following step b).

In a preferred embodiment, the porous monolithic carbon moulding obtained in step d) is at least partially embedded in a cladding in a further process step e).

The present invention also relates to porous carbon mouldings produced by the process according to the invention.

In a preferred embodiment, the mouldings have at least one bimodal pore distribution with macropores and mesopores in the walls of the macropores.

In a preferred embodiment, the mouldings have a total porosity of 60 to 80% by vol.

In another preferred embodiment, the mouldings have a surface area of between 2000 and 3000 m²/g.

In a preferred embodiment, the mouldings are at least partially embedded in a cladding.

The present invention also relates to a chromatographic separating column which contains a carbon moulding according to the invention as sorbent.

The present invention also relates to the use of the carbon mouldings according to the invention as electrodes in electrochemical cells, double-layer capacitors or fuel cells, as adsorbents for substances comprising liquids and gases (for example in the form of cigarette filters), as storage medium for gases, as support material in chromatographic applications or catalytic processes, as material in machine construction, as materials for flameproofing, for thermal insulation, in sensor technology, as pigments and electronic materials or in medical technology.

A moulding or monolithic moulding or monolith is in accordance with the invention a three-dimensional body, for example in the form of a column, cuboid, sphere, sheet, fibre, regularly or irregularly shaped particle or another moulding of any desired irregular shape. The term moulding, monolithic moulding or monolith also encompasses a layer of the material, for example on a surface or in a cavity.

The monolithic mouldings according to the invention are preferably columnar, i.e. cylindrical, or cuboid or particulate.

A carbon moulding is a moulding which consists at least for the most part of carbon.

The carbon formers employed can be substances which produce a three-dimensional framework consisting predominantly of carbon directly or after carbonisation or pyrolysis. Carbon formers of this type are known to the person skilled in the art. Examples are pitches, in particular mesophase pitch, or also furfuryl alcohol, fructose or naphthene. The carbon formers can be employed individually or in the form of a mixture of two or more carbon formers.

In accordance with the invention, the term pitch encompasses viscous to solid, tar-like or bituminous, fusible materials which remain behind, for example, on pyrolysis or distillation of organic materials (natural products) or of coal tar or lignite tar. In general, pitches are composed of high-molecular-weight cyclic hydrocarbons and heterocyclic compounds, which can have a molecular weight of up to 30,000 g/mol.

Mesophase pitch is a type of pitch which consists of various, principally aromatic hydrocarbons and comprises anisotropic liquid-crystalline regions. A review of the production and properties of mesophase pitch is given by Mochida et al., The Chemical Record, Vol. 2, 81-101 (2002). Mesophase pitch is commercially available, for example, from the Mitsubishi Gas Chemical Company.

The organic polymer employed can be any organic polymer having a Hildebrandt solubility parameter of between 8 and 12. The term organic polymer likewise encompasses mixtures of two or more corresponding organic polymers, which have different or identical molecular weights. The organic polymer employed can furthermore be a mixture comprising one organic polymer in two or more different molecular weights. The term organic polymer also encompasses copolymers or block copolymers, such as, for example, polyoxyethylene glycol ether (“Brij surfactants”) or poly(ethylene oxide)-b-poly(propylene oxides). In a preferred embodiment, the organic polymer employed is polystyrene. Poly(methyl methacrylate) (PMMA) is also a suitable organic polymer. The molecular weight of the polymers employed is typically between 500 g/mol and 1,000,000 g/mol, preferably between 10,000 and 500,000 g/mol. In principle, polymers having molecular weights of greater than 500,000 to 1,000,000 g/mol could also be employed. However, it has been found that polymers having higher molecular weights easily precipitate on removal of the solvent and can thus interfere with the phase separation. If mixtures of different polymers or mixtures of one polymer having different molecular weights are employed, a mixture of an organic polymer having a molecular weight of between 500 and 10,000 g/mol and an organic polymer having a molecular weight of between 50,000 and 500,000 g/mol is preferably employed. The later pore distribution in the moulding can be influenced by the choice of the organic polymer and its molecular weight or the molecular-weight distribution in the case of the use of polymer mixtures. The molecular weight and molecular-weight distribution determine the separation structure on evaporation of the solvent and thus the porosity. Lower molecular weights result in later separation and thus smaller pore systems.

The organic solvent employed can be any organic solvent or solvent mixture which dissolves the carbon former and the organic polymer in sufficient amount. It is furthermore advantageous if the solvent can be evaporated as simply as possible. Preference is therefore given to solvents having a low boiling point and/or high vapour pressure. Examples of suitable solvents are THF, CHCl₃ and xylene.

In accordance with the invention, evaporation means the at least partial removal of the organic solvent as far as the formation of a shapeable material. The evaporation can be carried out by simply leaving the mixture to stand, or accelerated, for example by generating the largest possible surface area, for example in a shallow container, increasing the temperature or generating a reduced pressure.

In accordance with the invention, melt extrusion means the introduction of a concentrated, shapeable material in the sense described into a heatable extrusion unit. The phase separation can be completed and/or the burning-out of the organic polymer at least begun in the extrusion unit. The melt extrusion results in the formation of a moulding.

In accordance with the invention, pyrolysis means heat treatment. In the process according to the invention, the organic polymer is generally at least partially burnt out by pyrolysis, i.e. removed or converted into non-graphitic carbon or graphite. Carbonisation is also a form of pyrolysis.

In accordance with the invention, carbonisation means the conversion of a carbon former into non-graphitic carbon or if appropriate graphite.

In order to carry out the process according to the invention for the production of porous monolithic carbon mouldings, a mixture is firstly produced which comprises at least one carbon former and one organic polymer in an organic solvent. The amount of solvent is not crucial here since it is later removed by evaporation. Suitable mixing ratios (carbon former/organic polymer:organic solvent) are typically at weight ratios between 1:100 and 3:1, depending on the solubility of the carbon former and the organic polymer in the organic solvent.

In accordance with the invention, the mixture which comprises at least one carbon former and one organic polymer in an organic solvent is preferably a solution. However, the mixture may also comprise small proportions of undissolved carbon former and/or organic polymer without the further performance of the process being adversely affected. Furthermore, other insoluble substances, such as inorganic pigments, particles or the like, may also be added to the mixture.

Furthermore, the mixture according to the invention can also be an emulsion. If the term “dissolve” is used below in connection with the preparation of the mixture which comprises at least one carbon former and one organic polymer in an organic solvent, “dissolve” means that at least the majority of the substances, preferably 70 to 95% of the respective component, but not necessarily 100% of the substances are brought into solution. If only a small proportion of a component can be dissolved, all or the majority of the remaining undissolved solid can be separated off by filtration or centrifugation/decantation. Carbon former and organic polymer are preferably in completely dissolved form.

Carbon former and organic polymer can firstly be dissolved separately in the organic solvent and subsequently mixed or directly dissolved simultaneously or successively in the organic solvent.

In general, carbon former and organic polymer are firstly dissolved separately in the organic solvent since in this case the solution properties of the components can be taken into account better. For example, it may be the case on use of pitches, such as mesophase pitch, that these components do not dissolve completely in the pre-specified amount of solvent. The person skilled in the art can then decide whether the amount of solvent should be increased or whether all or some of the undissolved fraction should be separated off, for example by centrifugation or filtration, before mixing with the organic polymer. The dissolution may in addition be supported, for example, by heating, vigorous stirring or ultrasound treatment.

If separate solutions of the carbon former and organic polymer in the organic solvent are firstly produced, the preferred concentrations of these solutions are 10-70% by weight, particularly preferably 40-70% by weight, of the carbon former, or 10 to 60% by weight, particularly preferably 30 to 60% by weight, of the organic polymer. The volume ratios between carbon former and organic polymer depend on the desired macroporosity. Typical volume ratios between carbon former and organic polymer are between 1:0.1 and 1:10, preferably between 1:0.5 and 1:4.

Accordingly, separate solutions of the carbon former and organic polymer in the organic solvent are preferably firstly prepared. These two solutions are then combined with one another with vigorous stirring. Vigorous stirring is typically also carried out for a further 1 to 60 minutes after the mixing.

Carbon former and organic polymer can also be dissolved in different solvents if, after the two solutions are combined, the final mixture comprising at least one carbon former and one organic polymer in an organic solvent is sufficiently homogeneous and no precipitation of one of the constituents is observed.

In addition, further substances can be added to the mixture of organic solvent, carbon former and organic polymer. These can be, for example, substances which influence the later separation, such as plasticisers, further solvents, surfactants, substances which influence the later carbonisation behaviour, such as, for example, Lewis acids, such as FeCl₃, or Fe, Co, Ni or Mn (see Marta Sevilla, Antonio Fuertes; Carbon 44 (2006), pages 468-474), or substances which influence the material properties of the later moulding, i.e., for example, introduce certain functionalities into the moulding. If these substances are insoluble in the organic solvent employed, an emulsion or suspension is of course formed.

On use of Lewis acids, these are preferably employed in an amount which corresponds to 0.1 to 10% of the proportion by weight of the carbon former.

The mixture which comprises at least one carbon former and one organic polymer in an organic solvent can be prepared batchwise or continuously by, for example, mixing two separate solutions (consisting at least of carbon former in organic solvent on the one hand and at least organic polymer in organic solvent on the other hand), for example in a static micromixer.

After the preparation of the homogeneous mixture which comprises at least one carbon former and one organic polymer in an organic solvent, the solvent is evaporated until an at least viscous or highly viscous material or a highly viscous or solid moulding is obtained. Some or virtually all of the solvent can be evaporated. The more completely the solvent is removed in this process step, the more viscous to solid the green body becomes. If it is desired to shape the green body, this can be carried out when the solvent has not yet completely evaporated and the green body is still viscous and directly shapeable, or after the complete or virtually complete removal of the solvent by making the highly viscous or solid green body more viscous and thus more shapeable again by gentle warming.

The shape of the resultant viscous material or moulding, also referred to as green body, is initially determined by the container in which the solvent is evaporated. After evaporation of the solvent, the green body can be heated directly without further treatment or shaping or firstly or simultaneously shaped, for example mechanically or thermally (for example by means of pressing, shaping or extrusion or melt extrusion). In particular, mouldings in the form of extrudates, meshes or hollow bodies can be produced by extrusion.

The at least partial phase separation for the formation of the macroporous structures can occur here both during evaporation of the solvent and also during subsequent mechanical or thermal treatment, for example melt extrusion. In general, the phase separation begins as early as during evaporation of the solvent and continues during subsequent mechanical and/or thermal treatment/shaping.

Equally, an extraction step can optionally be carried out before the heating of the moulding to temperatures between 200 and 4000° C. It can serve for extraction of an organic solvent, which can only be removed completely with difficulty by evaporation, or alternatively for removal of at least some of the organic polymer. The extraction step can thus replace all or some of the pyrolysis of the organic polymer. The extraction can be carried out with all aqueous or typically organic solvents or solvent mixtures. The person skilled in the art is able to select suitable solvents depending on the purpose of the extraction.

The moulding is heated to temperatures between 200 and 4000° C. This step is also known as carbonisation or pyrolysis, depending on the treatment conditions. The carbonisation or pyrolysis here can be carried out completely or incompletely—depending on the duration or temperature during the treatment.

This means that the carbon monolith formed consists virtually completely of carbon in the case of complete carbonisation and at least mostly of carbon in the case of incomplete carbonisation.

During the heating, the remaining organic polymer is burnt out or carbonised, and a pore structure is thus produced. Depending on the type of organic polymer, it may be the case that the organic polymer is burnt out virtually completely or alternatively a certain proportion of residues (principally carbon residues) from the organic polymer remains in the moulding.

In addition, the heating also changes the structure of the carbon former. For the pitch preferably employed in accordance with the invention or the meso-phase pitch particularly preferably employed as carbon former, it is known that a heat treatment or carbonisation causes a certain ordering of the material. Notes in this respect are given, for example, in Mochida et al., The Chemical Record, Vol. 2, 81-101(2002). Due to the temperature treatment, the graphenes grow laterally, and the graphene stacks grow in height. In addition, the degree of ordering of the graphene stack packing increases.

It has been found that the higher the carbonisation temperature and the more complete the carbonisation, the more the total porosity decreases, with the mesoporosity decreasing to a greater extent.

In a preferred embodiment, the heating is carried out to 200 to 4000° C. with exclusion of oxygen, i.e. under an inert-gas atmosphere. In particular, noble gases or nitrogen can be used.
In a preferred embodiment, the heating of the moulding is carried out stepwise, firstly to temperatures between 200 and 400° C. and then to temperatures between 500 and 1000° C.

The first heating to 200 to 400° C. serves for partial crosslinking of the carbon former and thus for the production/maturing of the separation structure which is relevant to the invention. This temperature is typically held for 1 hour to 48 hours. Depending on the intended use of the carbon monolith, the thermal treatment of the moulding may already be complete here.

Otherwise, heating is then preferably carried out to temperatures between 500 and 1000° C. in a second heating step. Here, the duration of the heating and the temperature level determine how completely the carbonisation is to be carried out. Overall, the duration of the carbonisation and the type of temperature programme during the carbonisation may again influence material properties, such as carbon proportion and porosity.

After the at least partial evaporation of the organic solvent and before, during or after the heating of the viscous material or moulding, activation may additionally be carried out. In accordance with the invention, activation means that the pore structure of the carbon moulding and/or the surface thereof is modified compared with a carbon monolith otherwise produced in the same way. Activation can be carried out, for example, by treating the green body before the heating with substances, such as acid, H₂O₂ or zinc chloride, which attack the structure of the moulding and result in a change in the pore structure, in particular during the subsequent heating, or chemically modify the surface of the moulding. Equally, substances of this type can be added during the heating, or heating can be carried out, for example, in a stream of oxygen. Activation forms of this type result, in particular, in the formation of micropores or another chemical functionalisation of the surface of the moulding, for example the formation of OH or COOH groups by oxidation.

The activated or non-activated carbon monoliths obtained after the heating can be employed directly for the further use or treated mechanically or chemically beforehand. For example, they can be cut to size by means of suitable saws or provided with certain chemical functionalities, i.e. activated, by means of chemical derivatisation methods. It is also possible to coat the carbon monoliths fully or partially with a layer of, for example, an organic or inorganic polymer.

It is thus possible in virtually any step of the process according to the invention to influence the material properties of the later carbon monolith or to introduce certain chemical functionalities by addition of certain substances. Stabilisers, substances for supporting carbonisation, inorganic particles or fibres, etc., can already be added, as described above, to the solution in step 1 of the process according to the invention.

The green body can be treated in similar form, in particular if the solvent has not yet evaporated completely.

The porous monolithic carbon mouldings according to the invention are distinguished by a specifically adjustable porosity. Due to their production by a process in which at least partial phase separation occurs, they have a monomodal, bimodal or oligomodal pore structure. In the case of a monomodal pore structure, in which the pores are produced, in particular, by phase separation, either macropores or mesopores are typically present. The process according to the invention preferably produces porous mouldings which have interconnected macropores or mesopores, enabling the flow of liquids or gases through the moulding. The size and number of the mesopores and micropores can be determined, for example, by the choice of the organic polymer and the concentration and molecular weight thereof. The pore size or pore-size distribution can also be influenced by the duration and temperature of the carbonisation step. The mesopore size can typically be set to between 2 and 100 nm, preferably between 5 nm and 30 nm, and the macropores typically have a size of greater than 100 nm, preferably greater than 1 micron, particularly preferably between 1 and 5 microns. The pore sizes of the micropores and mesopores are determined by means of nitrogen physisorption, those of the macropores by means of mercury porosimetry or scanning electron microscopy. Total porosities of greater than 50%, preferably between 60 and 80 per cent by volume, can easily be produced with retention of the favourable mechanical properties.

The production process according to the invention thus enables the porosity of the carbon monoliths to be adjusted in a targeted manner over a broad pore-size range and a hierarchical pore-size distribution to be produced. The specific surface area of the mouldings according to the invention is typically greater than 50 m²/g. Materials having surface areas greater than 500 m²/g, particularly preferably 1000 m²/g, are preferably produced. Particular preference is given to porous mouldings having surface areas of between 2000 and 3000 m²/g. The specific surface area is determined by means of nitrogen adsorption. The evaluation is carried out by the BET method.

The carbon mouldings according to the invention, in unmodified form or after subsequent treatment, can be employed, for example, as electrodes in electrochemical cells, such as double-layer capacitors or fuel cells, as adsorbents for substances comprising liquids and gases (for example as filters for air cleaning or in cigarettes), as support material in chromatographic applications or catalytic processes, as material in machine construction, as storage medium for gases, such as hydrogen or methane, as materials for flameproofing, for thermal insulation, in sensor technology, as pigments and electronic materials or in medical technology.

In the area of fuel cells, the carbon mouldings or powders produced therefrom can be employed as constituents of electrodes, in particular for the incorporation of catalytically active nanoparticles and for gas transport. In particular, a sufficiently good conductivity of the carbon material is required in fuel cells. The carbon mouldings according to the invention have adequate conductivity, in particular on use of mesophase pitch as carbon former.

The mouldings according to the invention can furthermore be employed in the area of chromatographic separation, in particular for applications with corrosive or redox-active substances, since the mouldings are chemically and physically inert, for example to acids and bases. In addition, the mouldings according to the invention are suitable for chromatographic applications using electric fields. For these applications, the material should be in the form of a monolithic moulding.

The mouldings according to the invention can in addition be fully or partially embedded in a cladding. In accordance with the invention, a cladding can be a holder or a three-dimensional moulding which has a recess into which the carbon moulding can be introduced fully or partially with the most accurate fit possible. Accordingly, a cladding can be, for example, a block of metal, plastic or ceramic into which one or more carbon mouldings can be fully or partially inserted, clamped, adhesively bonded or introduced in another manner.

In a preferred embodiment, a cladding is a holder or a sheath which completely or partially surrounds the moulding with an accurate fit and thus facilitates specific contact of the moulding with gases or liquids or in particular facilitates the targeted flow of gases or liquids through the moulding. This type of cladding is known, in particular, from the area of chromatography. Here, predominantly cylindrical porous mouldings are clad in such a way that gases or liquids are able to flow through the cylindrical moulding in the longitudinal direction from one end face to the other. The cladding here must fit accurately with a low dead volume.

It must furthermore be sufficiently stable that no liquid is able to exit the cladding, apart from at the end faces, even at a relatively high liquid pressure.

The cladding of the mouldings according to the invention can accordingly be carried out by methods which are already used, for example, for the production of chromatography columns. Suitable holders and claddings are known, for example, from WO 01/77660, WO 98/59238 and WO 01/03797. Suitable claddings with plastics can consist, for example, of PEEK or fibre-reinforced PEEK.

One way of producing monolithic mouldings clad in this way consists, for example, in extruding the plastic onto the moulding. In this case, the monolithic moulding is fed through a cross head in parallel to the extrusion of a tube. The freshly extruded tube surrounds (hot) the moulding and is additionally pressed against the moulding, for example by a pressure device. It is also possible here to warm a preformed tube instead of producing a tube by extrusion.

The mechanical pressure and the additional sintering during cooling produce a leakproof cladding. It is also possible to introduce the moulding into a prefabricated tube whose internal diameter is slightly larger than the external diameter of the moulding, and then to warm the plastic so that the tube can be reduced to the final diameter and surrounds the moulding in a leakproof manner.

In a further variant, the plastic cladding is produced by flame spraying or single or repeated shrinking. Other injection-moulding or melting processes are also suitable.

For use as chromatography column or also for other applications, the clad monoliths according to the invention can then be provided with corresponding connectors, filters, seals, etc.

The present invention therefore also relates to a chromatographic separating column which contains a carbon moulding according to the invention as sorbent. To this end, the carbon monolith is typically firstly derivatised using separation effectors, i.e., for example, biomolecules, for example enzymes, or metal catalysts, such as platinum or palladium, or also ionic, hydrophobic, chelating or chiral groups, and a ready-to-use chromatography column is subsequently produced from the resultant blank by cladding.

However, the moulding can also firstly be clad in its original form and then provided with the separation effectors in through-flow using an in-situ process.

In another embodiment, the monolithic mouldings according to the invention can be used in gas-tight containers or tanks for the accommodation, storage and delivery of at least one gas. Tanks of this type typically have to be designed in such a way that they withstand accommodation, storage and delivery of gases at pressures of 45-750 bar.

The carbon mouldings according to the invention are suitable for the storage and/or delivery of gases or gas mixtures which are in gas form approximately at room temperature or also above room temperature. Examples are saturated or unsaturated hydrocarbons (in particular methane, ethane, propane, ethylene, propylene, acetylene), saturated or unsaturated alcohols, oxygen, nitrogen, noble gases, CO, CO₂, synthesis gas or hydrogen.

The monolithic mouldings according to the invention can equally be employed in clad form in a fuel cell for the accommodation, storage and delivery of at least one gas (typically at pressures of 45-750 bar).

Owing to the high porosity and in particular in the case of the preferred at least bimodal pore distribution with macropores and mesopores in the walls of the macropores, the monolithic carbon mouldings according to the invention facilitate very much faster kinetics of the reversible incorporation/elimination or adsorption/desorption of diverse substances (for example analytes in the area of chromatography, gases or ions) compared with the prior art.

Even without further comments, it is assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications mentioned above and below, in particular the corresponding application EP 06011198.6, filed on 31, May, 2006, is incorporated into this application by way of reference.

### EXAMPLES

### 1. Production of a Carbon Monolith According to the Invention Using Polystyrene as Organic Polymer

### Variant A:

### 1.1 Preparation of the Precursor Solutions:

### Mesophase Pitch (MP) in THF:

Mesophase pitch (Mitsubishi AR) is introduced into a sealable recipient with THF (mesophase pitch:THF weight ratio 1:3). In order to dissolve the mesophase pitch, this is followed by ultrasound for 20 min (100%) and shaking in a horizontal shaker at low intensity. Alternatively, any other shaker or magnetic stirrer can also be used. After about 7 days, the mixture is centrifuged (10 min at 6500 rpm), and the solution then comprises about 10% by weight of MP. The undissolved mesophase pitch can be re-used. In order to initiate the carbonisation even at lower temperatures, a Lewis acid, for example FeCl₃, is added to the MP solution (1-10% by weight of FeCl₃ based on the solids content in the MP solution). The solution is then stirred vigorously for 15 min.

The organic polymer, here polystyrene (PS) (MW 250,000, Acros), is dissolved in THF (polystyrene:THF weight ratio 1:20).

### 1.2 Mixing of the Precursor Solutions:

The polystyrene solution is added dropwise with vigorous stirring to the MP solution. The relative amount of polystyrene to MP determines the final absolute porosity of the material.

The finished solution is then stirred vigorously again for 30 min.

### 1.3 Formulation and Shaping of the “Carbon Green Body”:

For separation, the solution is poured into a Petri dish. After evaporation of the THF, a thin layer of a PS/MP mixture remains behind.

### 1.4 Carbonisation:

The sample is partially crosslinked in the Petri dish for 48 h at 340° C. and under N₂.

For complete carbonisation with retention of the structure, a further heating step at 500-750° C. can be introduced, but this depends on the intended use of the porous carbon material.

### Characterisation:

The carbon material obtained in this way contains mesopores and macropores (determined by means of Hg porosimetry or scanning electron microscopy).

### Variant B

### 1.1 Preparation of the Precursor Solutions:

### Mesophase Pitch (MP) in THF:

Mesophase pitch (Mitsubishi AR) is introduced into a sealable recipient with THF (mesophase pitch:THF weight ratio 1:3). In order to dissolve the mesophase pitch, this is followed by ultrasound for 20 min (100%) and shaking in a horizontal shaker at low intensity. Alternatively, any other shaker or magnetic stirrer can also be used. After about 7 days, the mixture is centrifuged (10 min at 6500 rpm), and the solution then comprises about 10% by weight of MP. The solution is then diluted again with THF, so that the proportion of MP in the solution is about 2%. The undissolved mesophase pitch can be re-used. The solution is then stirred vigorously for 15 min.

The organic polymer, here polystyrene (PS) (MW 250,000, Acros), is dissolved in THF (polystyrene:THF weight ratio 1:60). In order to initiate the carbonisation of the mesophase pitch even at lower temperatures, a Lewis acid, for example FeCl₃, is added to the polymer solution (1-10% by weight of FeCl₃ based on the total weight of polymer and mesophase pitch).

### 1.2 Mixing of the Precursor Solutions:

The polystyrene solution is added to the MP solution with vigorous stirring. The relative amount of polystyrene to MP determines the final absolute porosity of the material. The finished solution is then stirred vigorously for about 12 hours.

### 1.3 Formulation and Shaping of the “Carbon Green Body”:

For separation, the solution is poured into a Petri dish or a crucible. After evaporation of the THF, a thin layer of a PS/MP mixture remains behind.

### 1.4 Carbonisation:

The sample is partially crosslinked for 10 hours at 300° C. (heating rate 1 K/min) under N₂. For complete carbonisation with retention of the structure, a further heating step at 500-750° C. can be introduced, but this depends on the intended use of the porous carbon material.

Porous bodies are also obtained by heat treatment at 340°0 C. for 48 hours (heating rate 1.5 K/min).

### Characterisation:

The carbon material obtained in this way contains mesopores and macropores (determined by means of Hg porosimetry, N₂ sorption or scanning electron microscopy).

### 2. Production of a Carbon Monolith According to the Invention Using PMMA as Organic Polymer

The carbon monolith is produced analogously to Example 1, variant B. Instead of PS, PMMA (MW 10,000-100,000) is used.

### 3. Production of a Carbon Monolith According to the Invention Using Brij 58 as Organic Polymer.

The carbon monolith is produced analogously to Example 1, variant A, in this case using precursor solutions:

### Mesophase Pitch (MP) in THF:

about 2 g of mesophase pitch (Mitsubishi AR)+10 g of THF+0.2 g of FeCl₃

### Solution of the Organic Polymer:

1 g of Brij 58+20 g of THF

1. Process for the production of porous carbon mouldings by
a) preparation of a mixture which comprises at least one carbon former and one organic polymer in an organic solvent
b) evaporation of the solvent until a viscous or highly viscous material or a corresponding moulding is obtained
c) optionally shaping of the material or moulding obtained in step b)
d) heating of the material or moulding from step b) or c) to temperatures between 200 and 4000° C.

2. Process according to claim 1, characterised in that the carbon former employed is pitch.

3. Process according to claim 1 characterised in that the carbon former employed is mesophase pitch.

4. Process according to claim 1 characterised in that the organic polymer employed is polystyrene.

5. Process according to claim 1, characterised in that a Lewis acid is added to the mixture in step a).

6. Process according to claim 1, characterised in that the heating of the moulding in step c) is carried out stepwise, firstly to temperatures between 200 and 400° C. and then to temperatures between 500 and 1000° C.

7. Process according to claim 1, characterised in that a mixture is prepared in step a) which comprises two or more different organic polymers of different molecular weight or one organic polymer in two or more different molecular weights.

8. Process according to claim 1, characterised in that one or more plasticisers are added to the mixture from step a).

9. Process according to claim 1, characterised in that the shaping in step c) is carried out by extrusion.

10. Process according to claim 1, characterised in that an extraction is carried out after step b) or step c).

11. Process according to claim 1, characterised in that the material or moulding is activated.

12. Process according to claim 1, characterised in that the porous carbon moulding obtained in step d) is fully or partially embedded in a cladding in a further process step e).

13. Porous carbon moulding produced by the process corresponding to claim 1.

14. Porous carbon moulding according to claim 13, characterised in that the moulding has at least one bimodal pore distribution with macropores and mesopores in the walls of the macropores.

15. Porous carbon moulding according to claim 13, characterised in that the moulding has a total porosity of 60 to 80% by vol.

16. Porous carbon moulding according to claim 13, characterised in that the moulding has a surface area of between 2000 and 3000 m²/g.

17. Porous carbon moulding according to claim 13, characterised in that the moulding is at least partially embedded in a cladding.

18. Chromatographic separating column which contains a porous carbon moulding according to claim 13 as sorbent.

19. Use of a porous carbon moulding according to claim 13 as electrode in electrochemical cells, double-layer capacitors or fuel cells, as adsorbent for substances comprising liquids and gases, as support material in chromatographic applications or catalytic processes, as storage medium for gases, as material in machine construction, as materials for flameproofing, for thermal insulation, in sensor technology, as pigment, electronic material or in medical technology.
